(19) United States
(12) Patent Application Publication
(10) Pub. No.: US 2002/0001045 A1
(43) Pub. Date: Jan. 3, 2002

(54) PARALLAX VIEWING SYSTEM

(76) Inventors: MINAKANAGURKI RANGANATH, LINCROFT, NJ (US); JOHN FRANK RIBERA, HOWELL, NJ (US)

Correspondence Address: KEVIN M. MASON, RYAN,MASON & LEWIS, LLP, 1300 POST ROAD, SUITE 205, FAIRFIELD, CT, 06430, US

(21) Appl. No.: 09/116,278

(22) Filed: Jul. 16, 1998

(51) Int. Cl. G02F 1/1335

(52) U.S. Cl. 349/11

(57) ABSTRACT

A parallax viewing system is disclosed that permits a viewer to change viewpoints and look around objects by providing the viewer with multiple viewpoints. The parallax viewing system can include a plurality of viewpoints in each viewing direction of a two dimensional display. A viewpoint/parallax generator causes a liquid crystal array to vary its viewing angle over time across a plurality of viewpoints 1 through N, while applying the appropriate image data for the respective viewpoint. The liquid crystal array or other suitable display technology is fabricated with a narrow viewing angle. The liquid crystal material should be selected to handle a wide bias voltage (contrast) variation. Thus, by varying the applied bias voltage, the viewing angle of the display system may be tuned from left to right, for example, by varying the bias voltage. In an illustrative three dimensional implementation, the input image signal is encoded with a left eye (LE) and right eye (RE) image for each viewpoint. In addition, the input image signal may optionally contain viewpoint data, including an indication of the viewing angle in each direction corresponding to the respective LE/RE image, for a variable viewpoint implementation.

### FIELD OF THE INVENTION

The present invention relates to a viewing system, and more particularly, to a method and apparatus for displaying images and multi-dimensional time-varying data with parallax viewing.

### BACKGROUND OF THE INVENTION

Conventional display systems exhibit parallax free viewing. Parallax free viewing occurs when an object being viewed does not reveal whatever is behind the object when the viewer changes his or her viewpoint from left to right. For example, the object 110 shown in FIG. 1A is directly in front of object 120, and the viewer is viewing the image from a viewpoint 1. If the viewer changes his or her viewing position to viewpoint 2 or viewpoint 3, as shown in FIG. 1B, in an attempt to see object 120, conventional display systems are still incapable of displaying object 120. Instead, conventional display systems will present the same view from viewpoints 2 and 3 as viewed from viewpoint 1. In other words, viewpoint 1 is repeated from all angles of the viewer's range.

Conventional display systems provide such a single viewpoint from all viewing angles to permit the viewer to view an image from various horizontal positions, at eye-level. In other words, conventional display systems are optimized for variations in horizontal viewing positions, while assuming the vertical viewing position will remain at a nominal eye level. Thus, current fabrication techniques for active matrix liquid crystal displays, for example, provide a single viewpoint with the widest possible horizontal viewing angle. In addition, conventional active matrix liquid crystal displays provide the greatest possible contrast over the wide angle.

Three dimensional display systems have generally required some form of eyewear, such as red and green glasses, liquid crystal shuttered glasses or polarized glasses, to achieve a three dimensional effect on a two dimensional display. However, such eyewear can be bulky and impractical for many applications and can add significant expense when an image must be presented to a group of individuals.

As apparent from the above-described deficiencies with conventional display systems, a need exists for an improved method and apparatus for displaying images with parallax viewing. A further need exists for a method and apparatus for displaying three dimensional images on a two dimensional display without requiring eyewear.

### SUMMARY OF THE INVENTION

Generally, according to one aspect of the present invention, a three dimensional parallax viewing system is disclosed that permits a viewer to change viewpoints and look around objects by providing the viewer with multiple viewpoints. The parallax viewing system can include a plurality of viewpoints in each viewing direction of a two dimensional display. A viewpoint/parallax generator causes a liquid crystal array to vary its viewing angle over time across a plurality of viewpoints 1 through N, while applying the appropriate image data for the respective viewpoint.

Accordance to a further aspect of the invention, the liquid crystal array (or other suitable display technology) is fabricated with a narrow viewing angle. In addition, the liquid crystal material should be selected to handle a wide bias voltage (contrast) variation. Thus, by varying the applied bias voltage, the viewing angle of the display system may be tuned from left to right, for example, by varying the bias voltage.

In an illustrative three dimensional implementation, the input image signal is encoded with a left eye (LE) and right eye (RE) image for each viewpoint. In addition, the input image signal may optionally contain viewpoint data, including an indication of the viewing angle in each direction corresponding to the respective LE/RE image, for a variable viewpoint implementation. The LE/RE image signals for each viewpoint can be obtained from a conventional three dimensional camera system. For example, one suitable three dimensional camera system is a dual camera system providing LE and RE image signals. Alternatively, an infinite number of viewpoints can be obtained, for example, using a 360° camera, or a 360° by 360° camera.

A more complete understanding of the present invention, as well as further features and advantages of the present invention, will be obtained by reference to the following detailed description and drawings.

### BRIEF DESCRIPTION OF DRAWINGS

FIGS. 1A and 1B illustrate the concept of parallax free and parallax viewing of two objects, respectively;

FIG. 2 is a schematic block diagram of an exemplary three dimensional parallax viewing system in accordance with the present invention;

FIG. 3 illustrates a representative input image encoded with left eye (LE) and right eye (RE) image data for a plurality of viewpoints;

FIG. 4 is a schematic block diagram of the viewpoint/parallax generator of FIG. 2;

FIG. 5 is a schematic block diagram of an alternative implementation of the three dimensional parallax viewing system of FIG. 2; and

FIG. 6 is a flow chart describing the processes performed by the viewpoint/parallax generator of FIG. 4.

### DETAILED DESCRIPTION

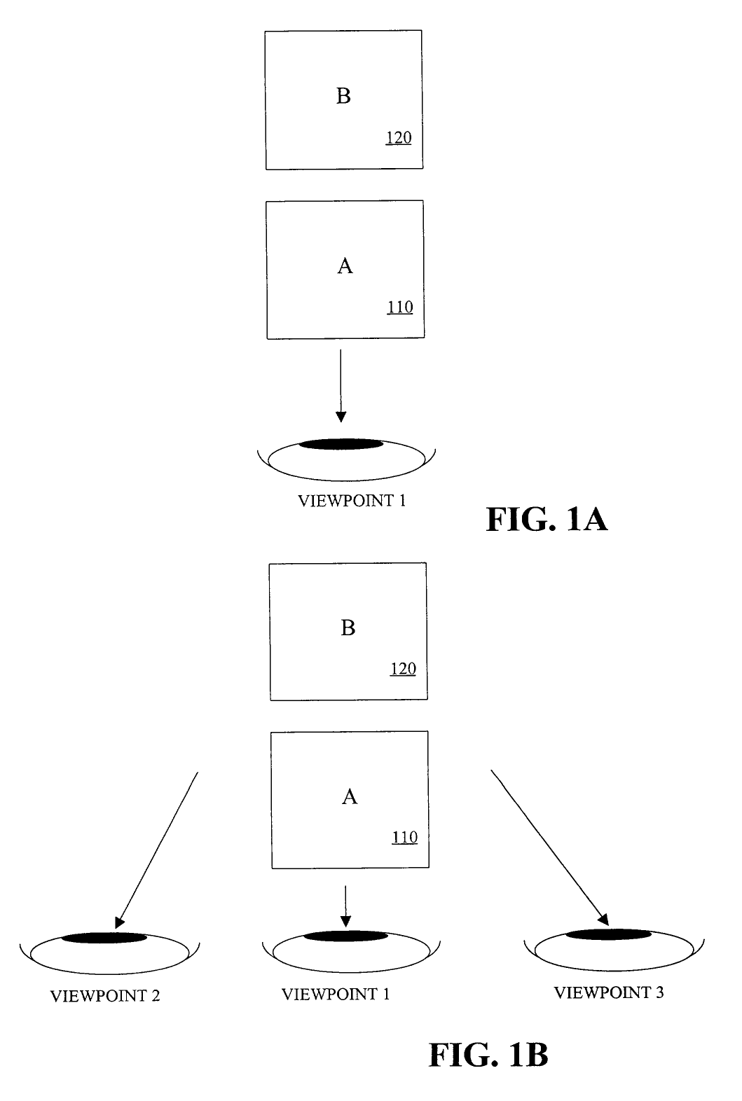

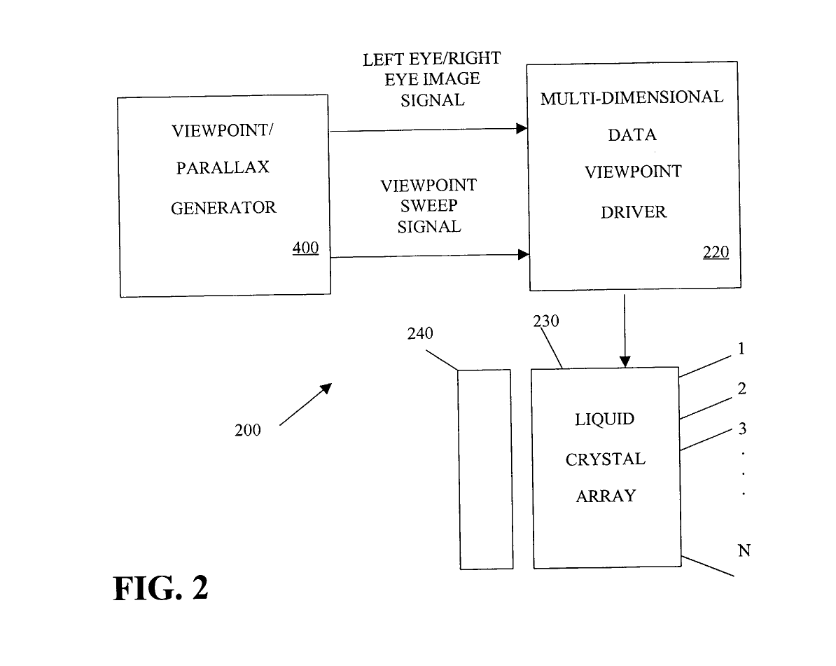

FIG. 2 illustrates a parallax viewing system 200 in accordance with the present invention. The illustrative parallax viewing system 200 shown in FIG. 2 is a three dimensional display system that also permits a viewer to change viewpoints and to look around objects by providing the viewer with multiple viewpoints. In the illustrative implementation disclosed herein, the parallax viewing system 200 provides three viewpoints, such as the three viewpoints shown in FIG. 1B. The parallax viewing system 200 could easily be extended, however, to include an infinite number of viewpoints for each direction in a two dimensional display, as would be apparent to a person of ordinary skill in the art based on the disclosure herein.

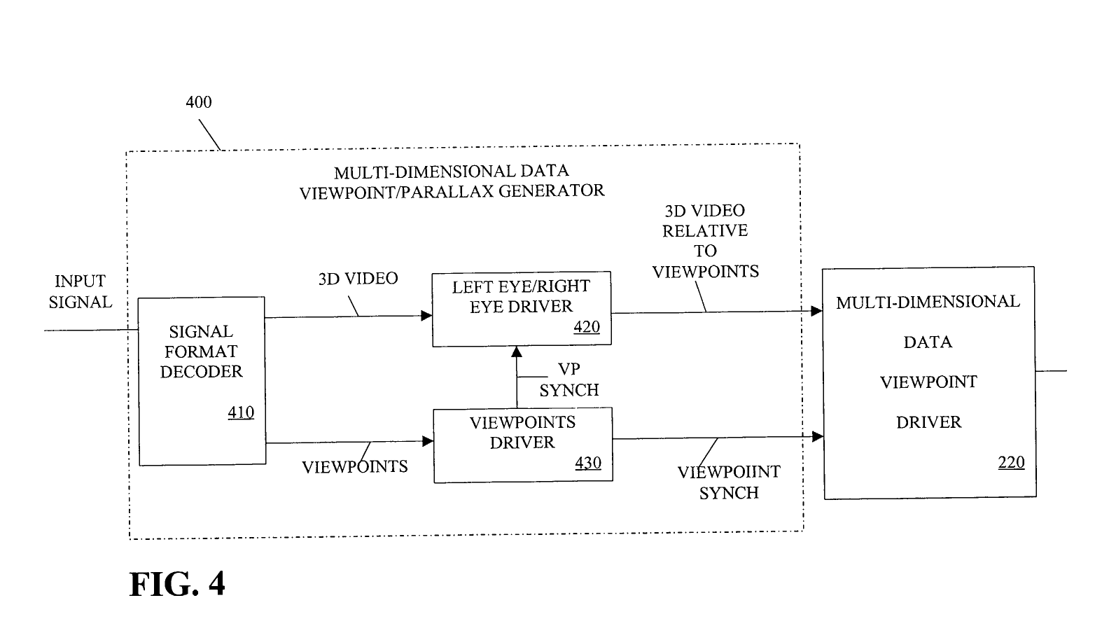

As shown in FIG. 2, the three dimensional parallax viewing system 200 includes a viewpoint/parallax generator (VPPG) 400, discussed further below in conjunction with FIG. 4, that provides a signal to a multi-dimensional data viewpoint driver 220. The driver 220 in turn causes a liquid crystal array 230 (or other suitable display technology) to vary its viewing angle over time across a plurality of viewpoints 1 through N, while applying the appropriate image data for the respective viewpoint. The liquid crystal array 230 may be backlit by a lighting source 240, in a known manner.

### LIQUID CRYSTAL ARRAY FABRICATION

In accordance with a feature of the present invention, the liquid crystal array 230 is fabricated with a narrow viewing angle, on the order of θₙ degrees. The magnitude of the viewing angle is application dependent, and varies, in part, in accordance with the number of desired viewpoints and the display technology used. The narrow viewing angle is necessary for achieving three dimensional viewing, as well as the parallax aspects of the display 230.

In addition, the liquid crystal material should be selected to handle a wide bias voltage (contrast) variation. In this manner, by varying the applied bias voltage the viewing angle of the display system 200 may be tuned from left to right, for example, by varying the bias voltage. As discussed further below, the bias voltage can be synchronized, for example, for left most viewing of the viewer's left eye or right most viewing of the viewer's right eye. It has been found that if the various left and right viewpoint images are modulated at a rate of 120 Hertz, for example, flicker is avoided, while producing a three dimensional image without the use of specialized eye wear.

### INPUT IMAGE SIGNAL

In a three dimensional implementation, the input image signal, is encoded with a left eye (LE) and right eye (RE) image for each viewpoint. For a two dimensional video signal, the input image signal would consist of a single image for each video frame, as would be apparent to a person of ordinary skill in the art. In addition, the input image signal may optionally contain viewpoint data, including an indication of the viewing angle in each direction corresponding to the respective LE/RE image, for a variable viewpoint implementation. As previously indicated, the illustrative parallax viewing system 200 disclosed herein provides the three viewpoints defined in FIG. 1B. Thus, since the viewing angles are known, they need not be transmitted with the LE/RE image data.

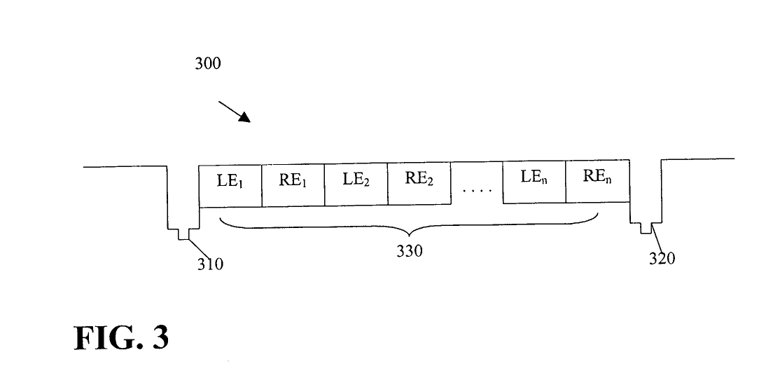

A representative input image signal format 300 for the illustrative three dimensional parallax viewing system 200 is shown in FIG. 3. The input image signal 300 includes the three dimensional (LE/RE) viewpoint image data 330 for a given scan line between two synchronization points 310, 320. The illustrative input image signal 300 consists of a series of left eye (LE) and right eye (RE) images for each available n viewpoints. It is noted that the odd and even fields of the video frame (where one odd and one even field comprises a single video frame) can be used to expand the number of viewpoints in a particular application with a specific display technology. In addition, standard video broadcast transmission, together with a decoder, can be used to send three dimensional parallax video.

The LE/RE image signals for each viewpoint can be obtained from a conventional three dimensional camera system (not shown). A left eye (LE) and right eye (RE) image can be obtained for a given viewpoint, for example, using two conventional cameras. For example, one suitable three dimensional camera system is a dual camera system providing LE and RE image signals. Alternatively, an infinite number of viewpoints can be obtained, for example, using a 360° camera, such as the camera disclosed in U.S. Pat. No. 5,745,305, entitled “Panoramic Viewing Apparatus,” assigned to the assignee of the present invention, incorporated by reference herein, as modified for a three dimensional viewpoint data video output format.

### VIEWPOINT/PARALLAX GENERATOR

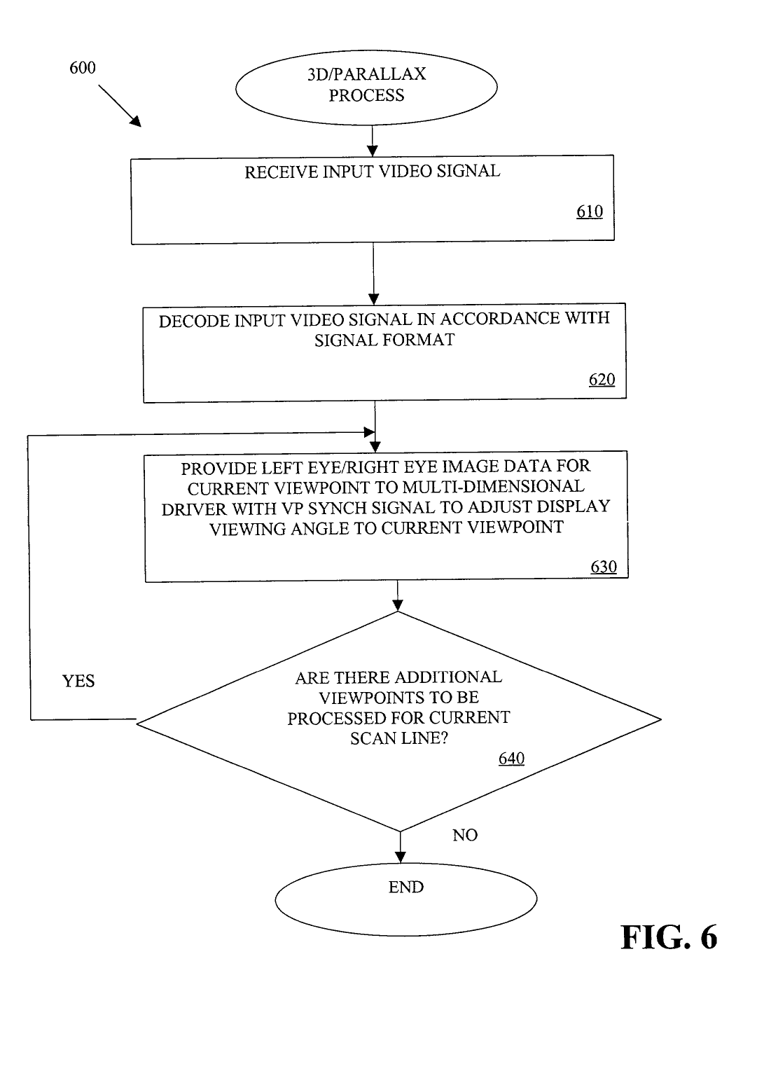

FIG. 4 provides a block diagram of the VPPG 400. The processes performed by the VPPG 400 are discussed below in conjunction with FIG. 6. The VPPG 400 includes a signal format decoder 410 to interpret the input image signal format, such as the input image signal 300 (FIG. 3). In addition, the VPPG includes a left eye/right eye driver 420 to generate a signal that provides for synchronization of the left eye (LE) and right eye (RE) image information present at the signal input to the liquid crystal array 230. In addition, the viewpoints driver 430 generates a signal that includes a plurality of viewing angles over time, thereby presenting the viewer with a plurality of viewpoints in real-time. In other words, the VPPG 400 synchronizes the viewing angle of the LCA 230 to the appropriate LE/RE image pair. Thus, as the image data LE₁ and RE₁, shown in FIG. 3, are presented, the VPPG 400 generates a signal that is provided to the multi-dimensional data viewpoint driver 220, and in turn the LCA 230, that adjusts the viewing angle of the display 230 to the angle corresponding to the first viewpoint. In this manner, the three dimensional parallax free viewing system 200 provides a three dimensional image with parallax viewing.

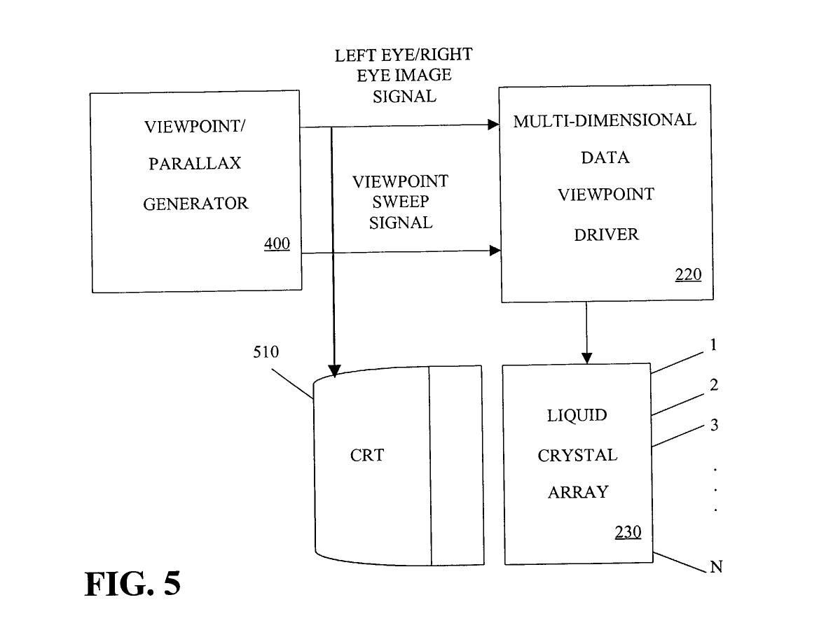

An alternate implementation of the three dimensional parallax free viewing system in accordance with the present invention is shown in FIG. 5. The three dimensional parallax free viewing system 500 shown in FIG. 5 utilizes cathode ray tube (CRT) technology. In the implementation of FIG. 5, the back lighting of FIG. 2 is replaced by a CRT display monitor 510 to provide the LE/RE image signals and inherent backlighting of the LCD 230. Thus, the LCD 230 now functions as a viewpoint filter and provides the parallax viewing capability, resulting in a three dimensional image with parallax viewing.

As previously indicated, the VPPG 400 executes a three dimensional/parallax process 600, shown in FIG. 6, to provide a three dimensional image with parallax viewing. The three dimensional/parallax process 600 initially receives the input video signal 300 (FIG. 3) during step 610. Thereafter, the input video signal 300 is decoded during step 620 in accordance with the defined (but arbitrary) signal format.

The left eye/right eye (LE/RE) image data for the current viewpoint is provided during step 630 to the multi-dimensional data viewpoint driver 220 with a viewpoint synchronization signal to adjust the viewing angle of the display 230 to the current viewpoint. A test is performed during step 640 to determine if there are additional viewpoints to be processed for the current scan line. If it is determined during step 640 that there are additional viewpoints to be processed for the current scan line, then program control returns to step 630 to process the remaining viewpoints in the manner described above.

If, however, it is determined during step 640 that there are no additional viewpoints to be processed for the current scan line, then program control terminates.

### APPLICATIONS

As previously indicated, the parallax viewing system 200 generally permits a viewer to change viewpoints and to look around objects by providing the viewer with multiple viewpoints. In an aircraft guidance system implementation, for example, the parallax viewing system 200 permits unobstructed views of the sky in heavy traffic areas. In addition, the parallax viewing system 200 can be utilized to simultaneously present the same information in a different format. For example, a document to be presented to an audience, for example, on a large screen, may be displayed simultaneously in different languages, with a first language version, such as an english language version, presented to the audience members associated with viewpoint 1 and one or more corresponding translated versions, such as german and french versions, simultaneously presented to the audience members associated with viewpoints 2 and 3, respectively.

Likewise, the parallax viewing aspects of the viewing system 200 can be utilized in a medical application to allow physicians to look around body objects during a surgical procedure using video assistance. In a further medical application, the parallax viewing system 200 can be utilized to simultaneously present the same information in a different format. For example, an anatomical view of a surgical procedure can to be presented to a surgeon in a first viewpoint, with a functional view of the surgical procedure, such as a positron emission tomograph (PET) or a single photon emission computer tomography (SPECT), presented to the surgeon in a second viewpoint. In addition, the viewing system can act as a multimodal fusion viewer to present a superimposed and calibrated image of both the anatomical and functional view can be simultaneously presented in a third viewpoint. In this manner, the viewing system 200 can be utilized both for the rehearsal and the actual surgical procedure. The present invention allows simultaneous presentation of data and visual objects in applications covering visualization of abstract data, such as an electro encephalogram (EEG) measuring brain signals through sensors distributed over the head.

In addition, the present invention allows a computer-aided drug design system, capable of receiving and transmitting spherical abstract data, and capable of feedback and subsequent control, such as designing a drug antibody for a virus antigen, to utilize a three dimensional spherical model display of the virus, providing real-time modification using spherical feedback.

It is to be understood that the embodiments and variations shown and described herein are merely illustrative of the principles of this invention and that various modifications may be implemented by those skilled in the art without departing from the scope and spirit of the invention.

We claim:

1. A method of presenting one or more objects on a display with parallax, said display having a plurality of viewing angles, said objects having a plurality of viewpoints, said method comprising the steps of:
obtaining at least one image for each of said viewpoints; and
synchronizing each of said viewpoint images to a corresponding viewing angle of said display.

2. The method according to claim 1, wherein said display is a liquid crystal array.

3. The method according to claim 1, wherein said display is a display technology capable of multiple viewing angles.

4. The method according to claim 1, wherein said display has a narrow viewing angle.

5. The method according to claim 1, wherein said display has a wide bias voltage variation.

6. The method according to claim 1, wherein said viewing angle is adjusted by adjusting the contrast of said display.

7. The method according to claim 1, wherein said obtaining at least one image for each of said viewpoints includes a left eye image and a right eye image and said display presents a three dimensional parallax view of said objects.

8. A method of presenting one or more objects on a three dimensional display with parallax, said display having a plurality of viewing angles, said objects having a plurality of viewpoints, said method comprising the steps of:
obtaining a three dimensional image for each of said viewpoints; and
synchronizing each of said viewpoint images to a corresponding viewing angle of said display.

9. The method according to claim 8, wherein said display is a liquid crystal array.

10. The method according to claim 8, wherein said display is a display technology capable of multiple viewing angles.

11. The method according to claim 8, wherein said display has a narrow viewing angle.

12. The method according to claim 8, wherein said display has a wide bias voltage variation.

13. The method according to claim 8, wherein said viewing angle is adjusted by adjusting the contrast of said display.

14. The method according to claim 8, wherein said three dimensional image for each of said viewpoints includes a left eye image and a right eye image.

15. A method of simultaneously presenting information on a display in a plurality of formats, said display having a plurality of viewing angles, said method comprising the steps of:
obtaining at least one image for each of said information formats; and
synchronizing each of said format images to a corresponding viewing angle of said display.

16. The method according to claim 15, wherein said information to be presented is a document including text and said plurality of formats includes the translation of said text into a plurality of languages.

17. The method according to claim 15, wherein said information to be presented is an anatomical view and a functional view of a surgical procedure.

18. The method according to claim 17, further comprising the step of simultaneously presenting a superimposed and calibrated image of said anatomical and functional view in a third viewpoint.

19. The method according to claim 17, further comprising the step of simultaneously presenting an image of sensor-mapping of data and visual objects in applications covering visualization of abstract data.

20. The method according to claim 17, further comprising the step of a computer-aided drug design system utilizing a three dimensional spherical model of a virus with real time modification using spherical feedback.

21. A display system for presenting one or more objects with parallax, said display having a plurality of viewing angles, said objects having a plurality of viewpoints, said display system comprising:
means for obtaining at least one image for each of said viewpoints; and
a processor for adjusting said viewing angle of said display and for synchronizing each of said viewpoint images to a corresponding viewing angle of said display.
